(19) United States
(12) Patent Application Publication
(10) Pub. No.: US 2022/0043459 A1
(43) Pub. Date: Feb. 10, 2022

(54) Systems and Methods for Relaying Requests to Autonomous Vehicles

(71) Applicant: Uber Technologies, Inc., San Francisco, CA (US)

(72) Inventor: Steve Ayers, Mars, PA (US)

(21) Appl. No.: 17/014,191

(22) Filed: Sep. 8, 2020

Related U.S. Application Data
(60) Provisional application No. 63/061,848, filed on Aug. 6, 2020.

(51) Int. Cl. G05D 1/02; H04L 29/08; G05D 1/00

(52) U.S. Cl. CPC G05D 1/0282; G05D 2201/0213; G05D 1/0088; H04L 67/12

(57) ABSTRACT

In one aspect a system for routing requests to autonomous vehicles can include a server computing system configured to perform operations including receiving, at the server computing system, a request from a downstream service; in response to receiving the request, automatically transmitting data describing a request identifier to the downstream service; determining, by the server computing system, that an autonomous vehicle computing system of an autonomous vehicle is available to receive the request; transmitting, from the server computing system to the autonomous vehicle computing system and in response to determining that the autonomous vehicle computing system is available to receive the request, data describing the request from the downstream service; receiving, from the autonomous vehicle computing system, a response from the autonomous vehicle computing system; and transmitting, from the server computing system to the downstream service, data describing the response in association with the request identifier.

### CROSS-REFERENCE TO RELATED APPLICATION

The present application claims filing benefit of U.S. Provisional Patent Application Ser. No. 63/061,848 having a filing date of Aug. 6, 2020, which is incorporated herein by reference in its entirety.

### FIELD

The present disclosure relates generally to vehicle networks for autonomous vehicles. More particularly, the present disclosure relates to systems and methods for relaying requests to autonomous vehicles.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or can be learned from the description, or can be learned through practice of the embodiments.

According to one aspect of the present disclosure, a system for routing requests to autonomous vehicles can include a server computing system comprising one or more processors and one or more non-transitory computer-readable media that collectively store instructions that, when executed by the one or more processors, cause the server computing system to perform operations. The operations can include receiving, at the server computing system, a request from a downstream service; in response to receiving the request, automatically transmitting data describing a request identifier to the downstream service; determining, by the server computing system, that an autonomous vehicle computing system of an autonomous vehicle is available to receive the request; transmitting, from the server computing system to the autonomous vehicle computing system and in response to determining that the autonomous vehicle computing system is available to receive the request, data describing the request from the downstream service; receiving, from the autonomous vehicle computing system, a response from the autonomous vehicle computing system; and transmitting, from the server computing system to the downstream service, data describing the response from the autonomous vehicle computing system in association with the request identifier.

According to another aspect of the present disclosure, a method for routing requests to autonomous vehicles can include receiving, by a server computing system comprising one or more computing devices, a request from a downstream service; in response to receiving the request, automatically transmitting, by the server computing system, data describing a request identifier to the downstream service; determining, by the server computing system, that an autonomous vehicle computing system of an autonomous vehicle is available to receive the request; transmitting, from the server computing system to the autonomous vehicle computing system and in response to determining that the autonomous vehicle computing system is available to receive the request, data describing the request from the downstream service; receiving, at the server computing system and from the autonomous vehicle computing system, a response from the autonomous vehicle computing system; and transmitting, from the server computing system to the downstream service, data describing the response from the autonomous vehicle computing system in association with the request identifier.

According to another aspect of the present disclosure one or more tangible, non-transitory, computer-readable media that collectively store instructions that, when executed by one or more processors, cause the one or more processors to perform operations. The operations can include receiving, by a server computing system comprising one or more computing devices, a request from a downstream service; in response to receiving the request, automatically transmitting, by the server computing system, data describing a request identifier to the downstream service; determining, by the server computing system, that an autonomous vehicle computing system of an autonomous vehicle is available to receive the request; transmitting, from the server computing system to the autonomous vehicle computing system and in response to determining that the autonomous vehicle computing system is available to receive the request, data describing the request from the downstream service; receiving, at the server computing system and from the autonomous vehicle computing system, a response from the autonomous vehicle computing system; and transmitting, from the server computing system to the downstream service, data describing the response from the autonomous vehicle computing system in association with the request identifier.

Other aspects of the present disclosure are directed to various systems, apparatuses, non-transitory computer-readable media, user interfaces, and electronic devices.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example system overview according to example implementations of the present disclosure.

FIG. 2 is a data flow for a system routing flowchart of a method for routing requests to autonomous vehicles according to example implementations of the present disclosure.

FIG. 3 is a simplified flowchart of a method for routing requests to autonomous vehicles according to example implementations of the present disclosure.

FIG. 4 depicts an example flow diagram of an example method for routing requests to autonomous vehicles according to example implementations of the present disclosure.

FIG. 5 depicts system components of an example system according to example implementations of the present disclosure.

FIG. 6 depicts system components of an example system according to example implementations of the present disclosure.

### DETAILED DESCRIPTION

Generally, the present disclosure is directed to systems and methods for relaying communications to autonomous vehicles. A server computing system can asynchronously relay communications between a downstream service and an autonomous vehicle system. Asynchronous relaying such communications can reduce a computational burden for the downstream service associated with retrieving responses from the autonomous vehicle system. More specifically, the server computing system can receive a request from a downstream service. The downstream service can be associated with, for example, an automotive vendor/manufacturer/provider, a computing hardware manufacturer, a sensor manufacturer, a software provider, and/or a service provider. For instance, the downstream service can include one or more back-end services associated with operating one or more autonomous vehicles (e.g., itinerary service, routing service, remote assistance) and/or maintaining the autonomous vehicles (e.g., a maintenance service). The downstream service can be or include any suitable entity that would benefit from asynchronous routing of requests or other communications with respect to the autonomous vehicle computing system. The request can include, for example, an inquiry regarding a current configuration of the autonomous vehicle (e.g., current software version, hardware model number, or the like) and/or a status inquiry. The status inquiry can request information about a current status for one or more systems of the vehicle computing system such as the onboard autonomy computing system, the mechanical systems, electrical systems, and the like. In response to receiving the request, the server computing system can automatically transmit (e.g., respond with) data describing a request identifier to the downstream service. The downstream service can use the request identifier to track the status of the request. The server computing system can determine that the autonomous vehicle computing system is available to receive the request. For example, the server computing system can detect and/or monitor when the autonomous vehicle system is available to receive the request (e.g., when the vehicle is in a powered-on state, is connected the server computing system, etc.). Once the autonomous vehicle system is available to receive the request, the server computing system can transmit data describing the request from the server computing system to the autonomous vehicle computing system. The server computing system can receive a response from the autonomous vehicle computing system and transmit, from the server computing system to the downstream service, data describing the response from the autonomous vehicle computing system in association with the request identifier. Thus, the server computing system can asynchronously relay requests and responses between downstream services and autonomous computing system.

In one example, it can be determined that a specific vehicle has an issue, such as a hardware or software flaw or malfunction, that could render it unsuitable for roads. For instance, a recall can be issued for a component currently operating on the vehicle or a problem can be detected with a current software version operation on the vehicle. A downstream service, such as a vehicle service assignment deployment service, a routing service, or the like, may issue a grounding request to the vehicle. The grounding request can instruct the vehicle to safely stop movement and/or cease autonomous operations. However, if that specific vehicle is currently offline, the vehicle may be unavailable to receive the grounding request. For instance, the vehicle could be in a service depot (e.g., garage, etc.) undergoing repair. The downstream service may not have access to a schedule or timeline indicating when the vehicle will come online again. However, it is desirable that this grounding message be delivered to the vehicle immediately once it is back online to prevent further movement and/or autonomous operation.

According to aspects of the present disclosure, instead of repeatedly attempting to transmit the grounding request, the downstream service can asynchronously route such a request to the autonomous vehicle via the server computing system. The server computing system can determine when the vehicle is available to receive the request and transmit the request at that time. Such asynchronous request delivery by the server computing system can eliminating the need for the downstream service to repeatedly attempt to transmit to the vehicle and/or query the vehicle to determine if it is available to receive the request. As such, asynchronous request delivery as described herein can save computational resources and/or communication bandwidth resources. For instance, asynchronous request delivery as described herein can reduce consumption of computational resources by the downstream service and/or reduce consumption of communication bandwidth between the downstream service and the server computing system and/or autonomous vehicle associated with repeated transmission attempts and/or vehicle status queries. Further, such asynchronous request relaying can eliminate the need for custom programming, logic, coding etc. at the downstream service to facilitate repeated attempts at transmitting the request. The server computing system can facilitate asynchronous request and/or message delivery according to specified rules, time to live (TTL) requirements, retry policies, or other suitable protocol or criteria.

Autonomous vehicles can be utilized by a service entity to provide vehicle services, which can be associated with a fleet of the service entity or a third-party. For example, the service entity may own, lease, etc. a fleet of autonomous vehicles that can be managed by the service entity (e.g., its backend system clients) to provide one or more vehicle services. An autonomous vehicle utilized to provide the vehicle service(s) can be included in this fleet of the service entity. Such autonomous vehicle may be referred to as “service entity autonomous vehicles” or “first party autonomous vehicles.” In some implementations, an autonomous vehicle can be associated with a third-party vehicle provider such as, for example, an individual, an original equipment manufacturer (OEM), a third-party vendor, or another entity. These autonomous vehicles may be referred to as “third-party autonomous vehicles.” Even though such an autonomous vehicle may not be included in the fleet of autonomous vehicles of the service entity, a service platform/operations computing system of the service entity can allow the autonomous vehicle(s) associated with a third-party to still be utilized to provide the vehicle services offered by the service entity, access the service entity's system back-ends systems, etc.

The service entity can utilize an operations computing system that provides a service infrastructure for monitoring, supporting, and maintaining the autonomous vehicles as well as for coordinating and managing the autonomous vehicles to provide vehicle services. For instance, the operations computing system can include a service platform. The service platform can include a plurality of back-end services and front-end interfaces, which are accessible via one or more APIs. For example, an autonomous vehicle and/or another computing system (that is remote from the autonomous vehicle) can communicate/access the service platform (and its backend services) by calling the one or more APIs. The service platform can include a plurality of back-end services such as, for example, a vehicle service assignment deployment service, a routing service, a remote assistance service, etc. These back-end service(s) can help coordinate and manage autonomous vehicles to provide vehicle services to users. The vehicle services can include, for example, user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services.

Downstream services may send requests to help facilitate the vehicle services. For example, a vehicle provider/vendor/manufacturer/etc. can transmit a request to schedule maintenance (e.g., in response to a recall). As another example, a computing hardware manufacturer or a sensor manufacturer can transmit a request to update software and/or firmware of one or more computing hardware components and/or sensor components of the autonomous vehicle. As a further example, a back-end service, such as an itinerary service and/or routing service of a service platform, can transmit a request that describes a pickup and/or drop-off location for a transportation request direction, an instruction to cease autonomous operation or cease all operations, and/or an instruction to proceed to a maintenance location for maintenance to be performed.

For example, the downstream services can request that the vehicles provide data describing a status of the vehicle and/or a status of the vehicle computing system at a variety of times and in response to a variety of circumstances and/or events. The status data can describe a change in status of an autonomous vehicle and/or reporting of an event with respect to the autonomous vehicle. As examples, the status data can describe events and/or status changes of the autonomous vehicle as part of a service (e.g., rideshare service), such as include picking up user(s), dropping off user(s), picking up item(s), dropping off item(s), and/or other status changes. As additional examples, the status data can indicate or describe the autonomous vehicle having a mechanical issue (e.g., flat tire, air conditioning malfunction, or the like), becoming delayed (e.g., by traffic). Additionally, in some embodiments, the autonomous vehicle can periodically provide status data that describes a location of the autonomous vehicle.

In some embodiments, the server computing system can facilitate delivery of the request to the autonomous vehicle computing system at a later time if the autonomous vehicle computing system is not immediately available to receive the request. More specifically, the server computing system can first determine that the autonomous vehicle computing system is unavailable to receive the request before later determining that the autonomous vehicle computing system has become available to receive the request. For example, the autonomous vehicle computing system can be unavailable due to being powered off, offline with respect to one or more networks and/or the service platform, or otherwise not currently configured to receive the request.

In some embodiments, the server computing system can monitor an availability status of the autonomous vehicle computing system for receiving the request after determining that the autonomous vehicle computing system of the autonomous vehicle is unavailable to receive the request. For example, the server computing system can periodically check the availability status of the autonomous vehicle computing system. As another example, the server computing system can determine when the autonomous vehicle computing system will be available to receive the request based on information available to the server computing system, such as maintenance logs, scheduled downtime, an estimated duration of a software update or other activity causing the autonomous vehicle computing system to be unavailable. Once the autonomous vehicle computing system becomes available to receive the request, the server computing system can transmit (e.g., relay) data describing the request from the downstream service to the autonomous vehicle computing system.

In some embodiments, the server computing system can transmit (e.g., relay) the data describing the response from the autonomous vehicle computing system in response to receiving a query from the downstream service that describes the request identifier. The server computing system can identify the relevant request to relay to the downstream service based on the request identifier. More specifically, before transmitting the data describing the response from the autonomous vehicle computing system from the server computing system to the downstream service, the server computing system can receive a query for the response from the downstream service. The server computing system can automatically transmit the data describing the response in response to the receiving the query.

However, in other embodiments, the server computing system can automatically transmit (e.g., relay) the data describing the response to the downstream service in response to receiving the response from the autonomous vehicle computing system. For instance, the server computing system can transmit the data describing the response without receiving a query for the response from the downstream service.

In some embodiments, the server computing system can store data describing the request and/or response at the server computing system (e.g., in a database and/or log). For example, the server computing system can automatically store the data describing the request in the database in response to receiving the request. As another example, the server computing system can automatically store the data describing the request in the database in response to receiving the request. For instance, data describing the request can include the request identifier, the response from the autonomous vehicle computing system, and/or metadata associated with the request or one or more components of the system. The server computing system can store metadata describing one or more of the above and/or describing the downstream service, the autonomous vehicle computing system, and/or the autonomous vehicle. For example, the server computing system can maintain a log of data relayed by the server computing system. The log can include information such as an identifier associated with the downstream service, the request identifier, and/or other information describing the downstream service and/or the request. Additional examples of information that can be stored at the server computing system can include a day, time, status, and the like of the request(s). Thus, the server computing system can store information describing relayed requests (e.g., in a database and/or log).

As indicated above, the server computing system can determine whether the autonomous vehicle computing system of the autonomous vehicle is available to receive the request. The server computing system can determine that the autonomous vehicle computing system is in a powered-on state, has connectivity with respect to the server computing system, and/or is otherwise suitable for receiving the request. Thus, the server computing system can determine that the autonomous vehicle computing system is available to receive the request before transmitting data describing the request to the autonomous vehicle computing system.

One or more criteria can define whether the autonomous computing system is available to receive the request. The criteria can be defined with respect to a power status, connectivity status, processor status, memory status, and/or any other suitable status of the autonomous computing system. For instance, the criteria can include one or more thresholds with respect to a currently available amount of processor capacity, a currently available amount of memory storage available, a currently available connectivity bandwidth, or the like. As additional examples, the criteria can include a minimum total memory capacity and/or total minimum processor capability. Thus, in some embodiments, the criteria can include specific criteria in addition to being in a powered-on state. Thus, the server computing system can determine whether the autonomous vehicle computing system of the autonomous vehicle is available to receive the request in a variety of manners and based on a variety of characteristics and/or statuses of the autonomous vehicle computing system.

In some embodiments, the server computing system can receive, from the downstream service, data that describes the one or more criteria for the autonomous vehicle computing system to be available to receive the request. For example, the downstream service can define conditions under which the request should be relayed to the autonomous vehicle computing system. The server computing system can determine that the autonomous vehicle computing system of the autonomous vehicle is available to receive the request by determining that the autonomous vehicle computing system satisfies the criteria described by the data received from the downstream service.

In one example embodiment a downstream service (e.g., a caller), can send a request to the server computing system. The server computing system can receive and process the request using an API, which may be referred to as an “AsyncRelayRequest.” The server computing system can assign a request identifier or operation ID and automatically transmit (e.g., return) data describing the operation ID to the caller. The server computing system can determine if the autonomous computing system is online. If the autonomous computing system is determined to not be available (e.g., online), the server computing system can update a record (e.g., at the server computing system) that describes the autonomous computing system as being unavailable. The server computing system can monitor a connection between the autonomous computing system and the server computing system to determine when the autonomous computing system becomes available.

If the server computing system determines that the autonomous computing system is online, the server computing system can transmit data describing the request from the caller/downstream service to the autonomous computing system. The server computing system can confirm that the data describing the request from the caller/downstream service was successfully sent to the autonomous computing system, for example, by receiving a confirmation message in response. However, if the server computing system does not confirm that the data describing the request was successfully sent, then the server computing system can update a record (e.g., at the server computing system) to describe the failed transmission status and/or describe the autonomous computing system unavailable.

If the server computing system confirms that the data describing the request from the downstream service (e.g., caller) was successfully sent to the autonomous computing system, the server computing system can receive a response from the autonomous vehicle computing system and update a record based on the response. The server computing system can transmit data describing the response from the autonomous vehicle computing system in association with the request identifier (e.g., operation ID) to the downstream service.

By utilizing the systems and methods described herein, a service entity can improve the ability for its infrastructure to communicate with and coordinate communications and/or assignments for its fleet of vehicles (e.g., autonomous vehicles). For example, the server computing system can communicate with a vehicle service assignment deployment back-end service of the service platform. The deployment back-end service can determine which of the vehicles (e.g., autonomous vehicles) are or will become available to provide vehicle services. The deployment back-end service can record vehicle service assignments to track which vehicles are currently assigned a vehicle service, projected to be assigned a vehicle service, may be finishing a vehicle service assignment, or not assigned a vehicle service assignment/available to do so. The server computing system can asynchronously route communications (e.g., requests, responses, instructions, etc.) between the deployment back-end service and the autonomous vehicle computing system according to aspects of the present disclosure.

The vehicle service assignment can be associated with a single or multiple mode itinerary. For example, a user can request transportation of the user from an origin location to a destination location. The deployment back-end service can determine that a vehicle is available to provide the vehicle service for the user, which can be stored with a current status of the vehicle. The deployment back-end service can determine that the vehicle is capable of transporting the user from the origin location to the destination location by retrieving the vehicles current location and operational capabilities (e.g., autonomy capabilities) from one or more databases and/or other services. The deployment back-end service can create an itinerary for the vehicle that includes data indicative of the origin/destination locations, a route for the vehicle, timing information (e.g., pick-up/drop-off time(s), etc.), user information (e.g., preferences, accommodates, etc.), and/or other information. The deployment back-end service can assign the itinerary to the vehicle by data indicative of the itinerary, user, etc. and communicating data indicative of the itinerary to the vehicle. The deployment back-end service can obtain data from the vehicle to ensure the itinerary is monitored in real-time (e.g., as the itinerary state changes from picking-up the user, travelling to the destination location, dropping-off the user, etc.). The server computing system can asynchronously route communications (e.g., requests, responses, instructions, etc.) between one or more of the back-end services (e.g., the deployment back-end service) and the vehicle computing system according to aspects of the present disclosure to facilitate one o or more of the operations described above.

As examples, a multi-modal transportation service can include travel by ground autonomous vehicle, travel by aircraft, and other suitable transportation modes (e.g., bus, boat (e.g., ferry), train, etc.). The various modalities can be provided by one or more service providers or service provider systems. For example, a first service provider computing device can provide and/or arrange a first transportation modality, a second service provider computing device can provide and/or arrange a second transportation modality, an Nth service provider computing device can provide and/or arrange an Nth transportation modality, and so forth.

The service platform can facilitate and select a multi-modal transportation service based on a variety of factors. One example factor includes the types of transportation modalities that are required, practical, and/or efficient to reach the destination, for example due to the autonomous capabilities of available vehicles, inaccessibility or impracticality of transport via particular transportation modalities. For instance, a land route over a bridge may take substantially longer than taking a ferry or air transportation over an intervening body of water. As another example factor, a user's preference or explicit selection of a specific transportation modality can be considered when facilitating a multi-model transport. For instance, a user can explicitly select or generally prefer an aerial transport, public transport, or another transportation modality. In such an instance, the platform can facilitate a multi-modal transportation service according to the user's preference or request. In the above examples, the service platform can facilitate such multi-modal trips of the vehicles (e.g., self-driving car, autonomous aircraft, etc.) with respect to the one or more legs of the itinerary that are provided by the service platform.

In some embodiments, a routing back-end service can improve the monitoring and coordination of vehicle routing. For example, the routing back-end service of the service platform obtain (e.g., via request, pull, etc.) data indicative of the software versions of the associated vehicle. The software versions can indicate, for example, whether an autonomous vehicle has the most recent autonomy software versions. This can help determine the best route for an autonomous vehicle to traverse while providing a vehicle service.

Additionally, the routing back-end service can assign, coordinate, monitor, adjust, etc. the user of one or more designated pick-up and/or drop-off zones. For example, the service entity can be associated with one or more designated pick-up and/or drop-off zones that can be utilized for its fleet of vehicles. These zones can be designated areas on and/or near a travel way or parking area where the vehicle can stop, park, pull-over, etc. The routing back-end service (and/or another service) can track which zones are being or are to be occupied by a vehicle, which zones are available, etc. The server computing system can asynchronously route communications (e.g., requests, responses, instructions, etc.) between one or more of the back-end services (e.g., the routing back-end service) and the vehicle computing system according to aspects of the present disclosure to facilitate one or more of the operations described above. For example, the server computing system can route a communication describing a location of pick-up zone, drop-off zone, or the like from the routing back-end service to the autonomous vehicle computing system.

In some implementations, relaying requests from downstream services as described herein can improve communications of the service entity's infrastructure. For instance, as described herein, the system and methods of the present disclosure can help avoid the need for downstream services to repeatedly query vehicles to facilitate vehicle services. Additionally, the service platform can coordinate and optimize the utilization of the service entity's vehicle fleet. Data can be stored indicating a location of the vehicle while the vehicle is offline (e.g., a storage area, parking area, service depot, etc.). Data can also be stored describing an offline time duration associated with a vehicle. The offline time duration can indicate how long the vehicle may be offline due, for example, due to maintenance, computing updates, refueling, data downloading, etc. A routing back-end service (or another service associated with supply positioning) can determine that it would be favorable to position one or more vehicles in a certain area before the vehicles go back online and become available to undertake vehicle service assignments. Additionally, or alternatively, the back-end service can determine whether the vehicle is in the appropriate location (e.g., service depot) and has enough time to receive a software update while the vehicle is offline. This can depend on whether the service depot has the hardware and/or communicability infrastructure to facilitate such a software updating process. The server computing system can utilize such data to determine when vehicle computing systems will be available to receive requests.

Example aspects of the present disclosure can provide for a number of technical effects and benefits, including improvements to computing systems. For example, the computational time and resources required to relay requests and/or messages to vehicles and/or relay responses from the vehicles be reduced by relaying such requests in an asynchronous manner as described herein. The server computing system can quickly respond to the downstream service with a request identifier that the downstream service can use to track its request. As such, that downstream service and server computing system can reserve resources that may otherwise be used repeatedly attempting to relay requests from the downstream service to the autonomous vehicle computing system when the autonomous vehicle computing system is unavailable. Instead, the server computing system can determine when the autonomous vehicle computing system is available to receive the request and transmit data describing the request at that time. Thus, the systems and methods disclosed herein can more efficiently allocate computational resources when relaying messages from downstream services to autonomous vehicle computing systems.

Another example technical effect and benefit can include relaying requests to autonomous vehicle computing systems based on the technical capability of the autonomous vehicle computing system to receive and/or process the request at that time. This technical capability can be determined based on one more technical criterion associated with the autonomous vehicle computing systems. Example technical criteria can include thresholds with respect to a currently available amount of processor capacity, a currently available amount of memory storage available, a currently available connectivity bandwidth, or the like of the autonomous vehicle computing system. As additional examples, the criteria can include a minimum total memory capacity and/or total minimum processor capability of the autonomous vehicle computing system. Thus, the system can facilitate delivery of requests when the autonomous vehicle computing system can adequately handle and/or process the requests based on technical capabilities and/or characteristics of the autonomous vehicle computing system and/or connectivity therewith. This can prevent the request from overloading the autonomous vehicle computing system at a time when the autonomous vehicle computing system is resource constrained and/or unprepared to receive and/or process the request. As a result, computational resources of autonomous vehicle computing system can be more intelligently allocated to important tasks (e.g., associated with operating the autonomous vehicle). Thus, the present methods can improve the safety and/or efficiency of relaying such messages.

Various means can be configured to perform the methods and processes described herein. For example, a computing system can include server unit(s), gateway server unit(s), vehicle provisioning unit(s), database server unit(s), vehicle computing unit(s), remote debugging unit(s) and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The system can include a database computing system. The database computing system can be included in the server computing system or separate and distinct from the server computing system. For example, the database computing system can automatically store the data describing the request in response to the server computing system receiving the request. As another example, the database computing system can automatically store the data describing the request in the database in response to receiving the request. For instance, data describing the request can include the request identifier the response from the autonomous vehicle computing system, and/or metadata associated with the request or one or more components of the system. The database computing system can store metadata describing one or more of the above and/or describing the downstream service, the autonomous vehicle computing system, and/or the autonomous vehicle. The database computing system can maintain a log of data relayed by the server computing system. The log can include information such as an identifier associated with the downstream service, the request identifier, and/or other information describing the downstream service and/or the request. Additional examples of information that can be stored at the database computing system can include a day, time, status, and the like of the request(s). Thus, the database computing system can store information describing relayed requests (e.g., in a database and/or log).

The system can include one or more downstream service unit(s). Alternatively, the downstream service unit(s) can be distinct and separate from the system. The downstream service unit(s) can include server computing devices or the like operated by equipment providers, vehicle manufacturers, and the like. The downstream service unit(s) can transmit requests to the server computing unit(s).

The means can be programmed to receive, at the server computing system, a request from a downstream service. The server computing system unit(s) and downstream service unit(s) are example means for performing the above steps.

The means can be programmed to automatically transmit data describing a request identifier to the downstream service in response to receiving the request. For instance, the means can generate the request identifier and send the request identifier to the downstream service before further processing or relaying the request. The server computing system unit(s) is one example means for performing the above steps.

The means can be programmed to determine that an autonomous vehicle computing system of an autonomous vehicle is available to receive the request. For example, the means can determine that the autonomous vehicle computing system is online, connected with the server computing system, and/or satisfy one or more other criteria (e.g., with respect to processing capability, memory capability, connectivity bandwidth, and the like). The server computing system unit(s) is one example means for performing the above steps.

The means can be programmed to transmit data describing the request from the downstream service to the autonomous vehicle computing system in response to determining that the vehicle computing system is available to receive the request. The server computing system unit(s) is one example means for performing the above steps.

The means can be programmed to receive from the autonomous vehicle computing system, a response from the autonomous vehicle computing system and transmitting, from the server computing system to the downstream service, data describing the response from the autonomous vehicle computing system in association with the request identifier. The server computing system unit(s) is one example means for performing the above steps.

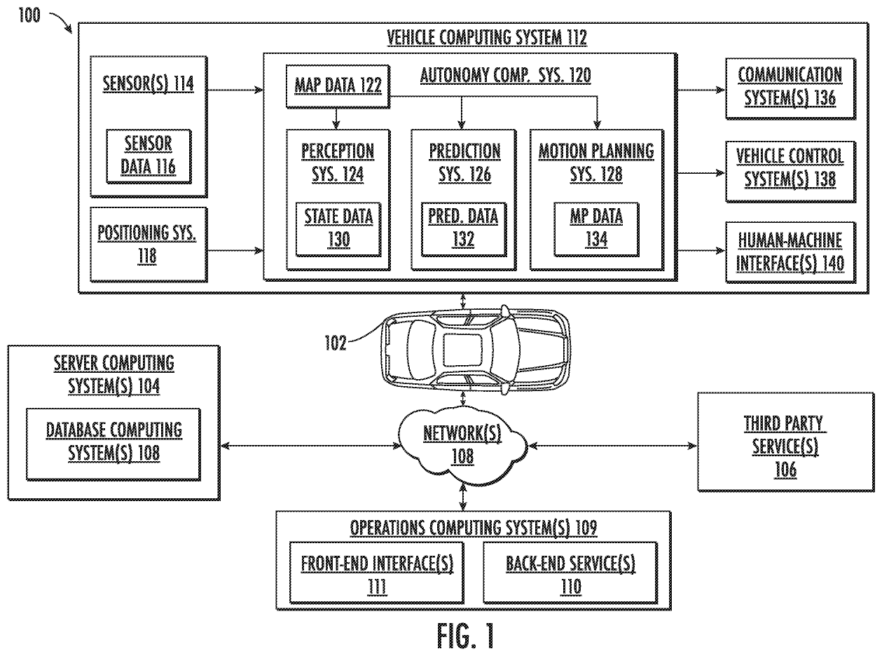

FIG. 1 depicts an example system 100 overview according to example implementations of the present disclosure. A vehicle computing system 112 aboard an autonomous vehicle 102 can communicate with a server computing system(s) 104 and/or one or more downstream services, such one or more third party service(s) 106 and/or operations computing system(s) 109. The server computing system 104 can asynchronously relay communications between the autonomous vehicle system 112 and the downstream service(s). Asynchronous relaying such communications can reduce a computational burden for the downstream service(s) associated with retrieving responses from the autonomous vehicle computing system 112. More specifically, the server computing system 104 can receive a request from the downstream service(s) (e.g., the third-party service(s) 106 and/or the operations computing system(s) 109). The downstream service can be associated with, for example, an automotive vendor/manufacturer/provider, a computing hardware manufacturer, a sensor manufacturer, a software provider, and/or a service provider. For instance, the downstream service can include one or more back-end services 110 associated with operating one or more autonomous vehicles (e.g., itinerary service, routing service, remote assistance) and/or maintaining the autonomous vehicles (e.g., a maintenance service). The downstream service can be or include any suitable entity that would benefit from asynchronous routing of requests or other communications with respect to the autonomous vehicle computing system. The request can include, for example, an inquiry regarding a current configuration of the autonomous vehicle 102 (e.g., current software version, hardware model number, or the like) and/or a status inquiry. The status inquiry can request information about a current status for one or more systems of the vehicle computing system 112 such as the onboard autonomy computing system 120, the mechanical systems, electrical systems, and the like. In response to receiving the request, the server computing system 104 can automatically transmit (e.g., respond with) data describing a request identifier to the downstream service (e.g., the third-party service(s) 106 and/or the operations computing system(s) 109). The downstream service can use the request identifier to track the status of the request. The server computing system 104 can determine that the autonomous vehicle computing system 112 is available to receive the request. For example, the server computing system 104 can detect and/or monitor when the autonomous vehicle system 112 is available to receive the request (e.g., when the vehicle is in a powered-on state, is connected the server computing system 104, etc.). Once the autonomous vehicle system 112 is available to receive the request, the server computing system 104 can transmit data describing the request from the server computing system 104 to the autonomous vehicle computing system 112. The server computing system 104 can receive a response from the autonomous vehicle computing system 112 and transmit, from the server computing system 104 to the downstream service, data describing the response from the autonomous vehicle computing system 112 in association with the request identifier. Thus, the server computing system 104 can asynchronously relay requests and responses between downstream services and autonomous computing system 112.

The vehicle computing system 112 can receive sensor data 116 from one or more sensors 114 that are coupled to or otherwise included within the autonomous vehicle 102. For example, in some implementations, a perception system 124 can be included within the vehicle computing system 112 and configured to receive the sensor data 116. As examples, the one or more sensors 114 can include a Light Detection and Ranging (LIDAR) system, a Radio Detection and Ranging (RADAR) system, one or more cameras (e.g., visible spectrum cameras, infrared cameras, etc.), a positioning system (e.g., GPS), and/or other sensors. The sensor data 116 can include information that describes the location of static objects and/or dynamic objects (actors) within the surrounding environment of the autonomous vehicle 102. For example, the objects can include traffic signals, additional vehicles, pedestrians, bicyclists, signs (e.g., stop signs, yield signs), and/or other objects. The sensor data 116 can include raw sensor data and/or data that has been processed or manipulated in some manner before being provided to other systems within the autonomy computing system.

In addition to the sensor data 116, the vehicle computing system 112 can retrieve or otherwise obtain map data 122 that provides detailed information about the surrounding environment of the autonomous vehicle 102. The map data 122 can provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, and/or instructions of signage (e.g., stop signs, yield signs), traffic lights (e.g., stop lights), or other traffic signals or control devices/markings (e.g., cross walks)); and/or any other map data 122 that provides information that assists the vehicle computing system 121 in comprehending and perceiving its surrounding environment and its relationship thereto.

Autonomous vehicles 102 can be utilized by the service entity to provide vehicle services can be associated with a fleet of the service entity or a third party. For example, the service entity may own, lease, etc. a fleet of autonomous vehicles 102 that can be managed by the service entity (e.g., its backend system clients) to provide one or more vehicle services. An autonomous vehicle 102 utilized to provide the vehicle service(s) can be included in this fleet of the service entity. Such autonomous vehicle 102 may be referred to as “service entity autonomous vehicles” or “first party autonomous vehicles.” In some implementations, an autonomous vehicle 102 can be associated with a third-party vehicle provider such as, for example, an individual, an original equipment manufacturer (OEM), a third-party vendor, or another entity. These autonomous vehicles 102 may be referred to as “third party autonomous vehicles.” Even though such an autonomous vehicle 102 may not be included in the fleet of autonomous vehicles 102 of the service entity, the service platform can allow the autonomous vehicle(s) 102 associated with a third party to still be utilized to provide the vehicle services offered by the service entity, access the service entity's system back-ends systems, etc.

The service entity can utilize an operations computing system 109 that provides a service infrastructure for monitoring, supporting, and maintaining the autonomous vehicles as well as for coordinating and managing the autonomous vehicles to provide vehicle services. For instance, the operations computing system 109 can include a service platform. In some embodiments, the operations computing system 109 can include one or both of the server computing system(s) 104 and the database server computing system(s) 108. The service platform (e.g., operations computing system(s) 109) can include a plurality of back-end services 110 and front-end interfaces 111. For example, an autonomous vehicle 102 and/or another computing system (that is remote from the autonomous vehicle 102) can communicate/access the service platform (and its backend services) by calling the one or more APIs. The service platform can include a plurality of back-end services 110 such as, for example, a vehicle service assignment deployment service, a routing service, a remote assistance service, etc. These back-end service(s) 110 can help coordinate and manage autonomous vehicles (e.g., a fleet associated with the service entity) to provide vehicle services to users. The vehicle services can include, for example, user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services.

Downstream services may send requests to help facilitate the vehicle services. The downstream services can be or include one or more of the third-party service(s) 106, back-end service(s) 110 of the operations computing system(s) 109 or any other suitable downstream service, as described herein. For example, a vehicle provider/vendor/manufacturer/etc. can transmit a request to schedule maintenance (e.g., in response to a recall). As another example, a computing hardware manufacturer or a sensor manufacturer can transmit a request to update software and/or firmware of one or more computing hardware components and/or sensor components (e.g., sensor(s) 114) of the autonomous vehicle 102. As a further example, the back-end service 110, such as an itinerary service and/or routing service of a service platform, can transmit a request that describes a pickup and/or drop-off location for a transportation request direction, an instruction to cease autonomous operation or cease all operations, and/or an instruction to proceed to a maintenance location for maintenance to be performed.

For example, the downstream services can request that the vehicles 102 provide data describing a status of the vehicle and/or a status of the vehicle computing system 112 at a variety of times and in response to a variety of circumstances and/or events. The status data can describe a change in status of an autonomous vehicle 102 and/or reporting of an event with respect to the autonomous vehicle 102. As examples, the status data can describe events and/or status changes of the autonomous vehicle 102 as part of a service (e.g., rideshare service), such as include picking up user(s), dropping off user(s), picking up item(s), dropping off item(s), and/or other status changes. As additional examples, the status data can indicate or describe the autonomous vehicle having a mechanical issue (e.g., flat tire, air conditioning malfunction, or the like), becoming delayed (e.g., by traffic). Additionally, in some embodiments, the autonomous vehicle 102 can periodically provide status data that describes a location of the autonomous vehicle 102.

In some embodiments, the server computing system 104 can facilitate delivery of the request to the autonomous vehicle computing system 112 at a later time if the autonomous vehicle computing system 112 is not immediately available to receive the request. More specifically, the server computing system 104 can first determine that the autonomous vehicle computing system 112 is unavailable to receive the request before later determining that the autonomous vehicle computing system 112 has become available to receive the request. For example, the autonomous vehicle computing system 112 can be unavailable due to being powered off, being offline with respect to one or more networks and/or the service platform, or otherwise not currently being configured to receive the request.

In some embodiments, the server computing system 104 can monitor an availability status of the autonomous vehicle computing system 112 for receiving the request after determining that the autonomous vehicle computing system 112 of the autonomous vehicle 102 is unavailable to receive the request. For example, the server computing system 104 can periodically check the availability status of the autonomous vehicle computing system 112. As another example, the server computing system 104 can determine when the autonomous vehicle computing system 112 will be available to receive the request based on information available to the server computing system 104, such as maintenance logs, scheduled downtime, an estimated duration of a software update or other activity causing the autonomous vehicle computing system 112 to be unavailable. Once the autonomous vehicle computing system 112 becomes available to receive the request, the server computing system 104 can transmit (e.g., relay) data describing the request from the downstream service to the autonomous vehicle computing system 112.

In some embodiments, the server computing system 104 can transmit (e.g., relay) the data describing the response from the autonomous vehicle computing system 112 in response to receiving a query from the downstream service that describes the request identifier. The server computing system 104 can identify the relevant request to relay to the downstream service based on the request identifier. More specifically, before transmitting the data describing the response from the autonomous vehicle computing system 112 from the server computing system 104 to the downstream service, the server computing system 104 can receive a query for the response from the downstream service. The server computing system 104 can automatically transmit the data describing the response in response to the receiving the query.

However, in other embodiments, the server computing system 104 can automatically transmit (e.g., relay) the data describing the response to the downstream service in response to receiving the response from the autonomous vehicle computing system 112. For instance, the server computing system 104 can transmit the data describing the response without receiving a query for the response from the downstream service.

In some embodiments, the server computing system 104 can store data describing the request and/or response at the server computing system 104, for example in one or more database computing system(s) 108 of the server computing system 104. For example, the server computing system 104 can automatically store the data describing the request in response to receiving the request. As another example, the server computing system 104 can automatically store the data describing the request in response to receiving the request. For instance, data describing the request can include the request identifier, the response from the autonomous vehicle computing system 112, and/or metadata associated with the request or one or more components of the server computing system(s) 104, operations computing system(s) 109 and/or third party service(s) 106. The server computing system 104 can store metadata describing one or more of the above and/or describing the downstream service, the autonomous vehicle computing system 112, and/or the autonomous vehicle 102. For example, the server computing system 104 can maintain a log of data relayed by the server computing system 104. The log can include information such as an identifier associated with the downstream service, the request identifier, and/or other information describing the downstream service and/or the request. Additional examples of information that can be stored at the server computing system 104 can include a day, time, status, and the like of the request(s). Thus, the server computing system 104 can store information describing relayed requests (e.g., in the database computing system(s) 108).

As indicated above, the server computing system 104 can determine whether the autonomous vehicle computing system 112 of the autonomous vehicle 102 is available to receive the request. The server computing system 104 can determine that the autonomous vehicle computing system 112 is in a powered-on state, has connectivity with respect to the server computing system 104, and/or is otherwise suitable for receiving the request. Thus, the server computing system 104 can determine that the autonomous vehicle computing system 112 is available to receive the request before transmitting data describing the request to the autonomous vehicle computing system 112.

One or more criteria can define whether the autonomous computing system 112 is available to receive the request. The criteria can be defined with respect to a power status, connectivity status, processor status, memory status, and/or any other suitable status of the autonomous computing system 112. For instance, the criteria can include one or more thresholds with respect to a currently available amount of processor capacity, a currently available amount of memory storage available, a currently available connectivity bandwidth, or the like. As additional examples, the criteria can include a minimum total memory capacity and/or total minimum processor capability. Thus, in some embodiments, the criteria can include specific criteria in addition to being in a powered-on state. Thus, the server computing system 104 can determine whether the autonomous vehicle computing system 112 of the autonomous vehicle is available to receive the request in a variety of manners and based on a variety of characteristics and/or statuses of the autonomous vehicle computing system 112.

In some embodiments, the server computing system 104 can receive, from the downstream service, data that describes the one or more criteria for the autonomous vehicle computing system 112 to be available to receive the request. For example, the downstream service can define conditions under which the request should be relayed to the autonomous vehicle computing system 112. The server computing system 104 can determine that the autonomous vehicle computing system 112 of the autonomous vehicle 102 is available to receive the request by determining that the autonomous vehicle computing system 112 satisfies the criteria described by the data received from the downstream service.

One or more aspects the present disclosure can be performed with a back-end service 110 and/or front-end interface 111. Vehicle service assignment can be associated with a single or multiple mode itinerary. For example, a user can request transportation of the user from an origin location to a destination location. The deployment back-end service 110 can determine that a vehicle is available to provide the vehicle service. The deployment back-end service 110 can determine that the vehicle is capable of transporting the user from the origin location to the destination location by retrieving the vehicles current location and operational capabilities (e.g., autonomy capabilities) from one or more databases and/or other services. The deployment back-end service 110 can create an itinerary for the vehicle that includes data indicative of the origin/destination locations, a route for the vehicle, timing information (e.g., pick-up/drop-off time(s), etc.), user information (e.g., preferences, accommodates, etc.), and/or other information. The deployment back-end service 110 can assign the itinerary to the vehicle. The deployment back-end service 110 can communicate data to the vehicle to ensure that it is routed properly and/or to ensure the itinerary is monitored in real-time (e.g., as the itinerary state changes from picking-up the user, travelling to the destination location, dropping-off the user, etc.).

In some implementations, a multi-modal itinerary can be generated for the user. For example, a multi-modal transportation service can include travel by ground autonomous vehicle, travel by aircraft, and other suitable transportation modes (e.g., bus, boat (e.g., ferry), train, etc.). The various modalities can be provided by one or more service providers or service provider systems. For example, a first service provider computing device can provide and/or arrange a first transportation modality, a second service provider computing device can provide and/or arrange a second transportation modality, an Nth service provider computing device can provide and/or arrange an Nth transportation modality, and so forth.

The service platform can facilitate and select a multi-modal transportation service based on a variety of factors. One example factor includes the types of transportation modalities that are required, practical, and/or efficient to reach the destination, for example due to the autonomous capabilities of available vehicles, inaccessibility or impracticality of transport via particular transportation modalities. For instance, a land route over a bridge may take substantially longer than taking a ferry or air transportation over an intervening body of water. As another example factor, a user's preference or explicit selection of a specific transportation modality can be considered when facilitating a multi-model transport. For instance, a user can explicitly select or generally prefer an aerial transport, public transport, or another transportation modality. In such an instance, the platform can facilitate a multi-modal transportation service according to the user's preference or request. In the above examples, the service platform can facilitate and/or monitor such multi-modal trips by relaying requests as described herein with vehicles (e.g., self-driving car, autonomous aircraft, etc.) along one or more legs of the itinerary that are provided by the service platform.

In some implementations, asynchronous routing of communications as described herein can be utilized to facilitate communications to vehicles 102 when they become available to receive the communications. For example, an offline time duration can indicate how long the vehicle 102 may be offline due, for example, due to maintenance, computing updates, refueling, data downloading, etc. The routing back-end service 110 (or another service associated with supply positioning) can determine that it would be favorable to position one or more vehicles 102 in a certain area before the vehicles 102 go back online and become available to undertake vehicle service assignments. The back-end service 110 can determine which vehicle(s) 102 can be re-positioned from their current locations to desired certain areas in the most efficient manner, before those vehicles 102 go online with the service platform. Additionally, or alternatively, the back-end service 110 can determine whether the vehicle 102 is in the appropriate location (e.g., service depot) and has enough time to receive a software update while the vehicle 102 is offline. This can depend on whether the service depot has the hardware and/or communicability infrastructure to facilitate such a software updating process.

The downstream service (e.g., back-end service(s) 110) and/or third-party service(s) 106)) can be associated with, for example, an automotive vendor/manufacturer/provider, a computing hardware manufacturer, a sensor manufacturer, a software provider, and/or a service provider. For instance, the downstream service can include the back-end service(s) 110 associated with operating one or more autonomous vehicles 102 (e.g., itinerary service, routing service, remote assistance) and/or maintaining the autonomous vehicles (e.g., a maintenance service). The downstream service can be or include any suitable entity that would benefit from asynchronous routing of requests or other communications with respect to the autonomous vehicle computing system. The request can include, for example, an inquiry regarding a current configuration of the autonomous vehicle (e.g., current software version, hardware model number, or the like) and/or a status inquiry. The status inquiry can request information about a current status for one or more systems of the vehicle computing system 112 such as the onboard autonomy computing system 120, sensor(s) 114, mechanical systems, electrical systems, and the like of the vehicle 102. In response to receiving the request, the server computing system 104 can automatically transmit (e.g., respond with) data describing a request identifier to the downstream service. The downstream service can use the request identifier to track the status of the request.

In some embodiments, the server computing system 104 can determine that the autonomous vehicle computing system 112 is available to receive the request. For example, the server computing system 104 can detect and/or monitor when the autonomous vehicle system 112 is available to receive the request (e.g., when the vehicle 102 is in a powered-on state, is connected the server computing system 104, etc.). Once the autonomous vehicle system 112 is available to receive the request, the server computing system 104 can transmit data describing the request from the server computing system 104 to the autonomous vehicle computing system 112. The server computing system 104 can receive a response from the autonomous vehicle computing system 112 and transmit, from the server computing system 104 to the downstream service, data describing the response from the autonomous vehicle computing system 112 in association with the request identifier. Thus, the server computing system 104 can asynchronously relay requests and responses between downstream services and autonomous computing system(s) 112.

In one example, it can be determined that a specific vehicle 102 has an issue, such as a hardware or software flaw or malfunction that could render it unsuitable for roads. For instance, a recall can be issued for a component currently operating on the vehicle 102 or a problem can be detected with a current software version operation on the vehicle computing system 112 and/or autonomy computing system 120. For instance, a problem can be detected for one or more of the perception system 124, prediction system 126, motion planning system 128, communication system(s) 136, vehicle control system(s) 138, human-machine interface(s) 140, positioning system(s) 118), sensor(s) 114 or the like.

The downstream service, such as a vehicle service assignment deployment service, a routing service, or the like, (e.g., included in the third party service(s) 106 and/or back-end service(s) of the operations computing system(s) 109) may issue a grounding request to the vehicle 102. The grounding request can instruct the vehicle 102 to safely stop movement and/or cease autonomous operations. However, if that specific vehicle 102 is currently offline, the vehicle 102 may be unavailable to receive the grounding request. For instance, the vehicle 102 could be in a service depot (e.g., garage, etc.) undergoing repair. The downstream service may not have access to a schedule or timeline indicating when the vehicle 102 will come online again. However, it is desirable that this grounding message be delivered to the vehicle 102 immediately once it is back online to prevent further movement and/or autonomous operation.

According to aspects of the present disclosure, instead of repeatedly attempting to transmit the grounding request, the downstream service can asynchronously route such a request to the autonomous vehicle 102 via the server computing system 104. The server computing system 104 can determine when the vehicle 102 is available to receive the request and transmit the request at that time. Such asynchronous request delivery by the server computing system 104 can eliminating the need for the downstream service to repeatedly attempt to transmit to the vehicle 102 and/or query the vehicle 102 to determine if it is available to receive the request. As such, asynchronous request delivery as described herein can save computational resources and/or communication bandwidth resources. For instance, asynchronous request delivery as described herein can reduce consumption of computational resources by the downstream service (e.g., the operations computing system(s) 109 and/or third party service(s) 106) and/or reduce consumption of communication bandwidth between the downstream service and the server computing system 104 and/or autonomous vehicle 102 associated with repeated transmission attempts and/or vehicle status queries. Further, such asynchronous request relaying can eliminate the need for custom programming, logic, coding etc. at the downstream service (e.g., operations computing system(S) 109, third party service(s) 106) to facilitate repeated attempts at transmitting the request. The server computing system 104 can facilitate asynchronous request and/or message delivery according to specified rules, time to live (TTL) requirements, retry policies, or other suitable protocol or criteria.

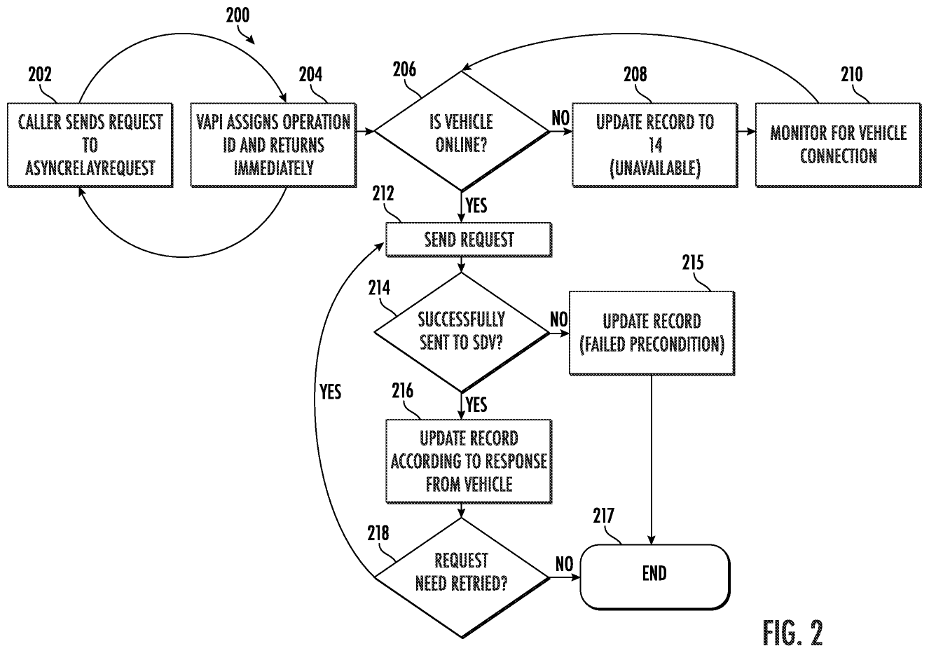

FIG. 2 is a simplified schematic of a data flow 200 for a system routing requests to autonomous vehicles according to example implementations of the present disclosure. At (202), a downstream service (e.g., a caller), can send a request to the server computing system. The server computing system, at (204), can assign a request identifier or operation ID and automatically transmit (e.g., return) data describing the operation ID to the caller. At (206), the server computing system can determine if the autonomous computing system is online or otherwise available to receive the request. In some embodiments, the downstream service can specify one or more criteria for determining that the autonomous computing system and/or autonomous vehicle is available to receive the request. The server computing system can determine, at (206), whether the autonomous computing system and/or autonomous vehicle satisfies such criteria. If the autonomous computing system is determined to not be available (e.g., online), the server computing system, at (208), can update a record (e.g., at the server computing system) that describes the autonomous computing system as being unavailable. At (210), the server computing system can monitor a connection between the autonomous computing system and the server computing system to determine when the autonomous computing system becomes online and/or available to receive the request.

If the server computing system determines that the autonomous computing system is online and/or available at (206), the server computing system, at (212), can transmit data describing the request from the caller/downstream service to the autonomous computing system. The server computing system, at (214) can confirm that the data describing the request from the caller/downstream service was successfully sent to the autonomous computing system, for example, by receiving a confirmation message in response. However, if the server computing system does not confirm that the data describing the request was successfully sent, at (214), then the server computing system, at (215), can update a record (e.g., at the server computing system) to describe the failed transmission status and/or describe the autonomous computing system unavailable. After updating the record, at (216), the method can end at (217).

If the server computing system confirms that the data describing the request from the downstream service (e.g., caller) was successfully sent to the autonomous computing system, at (214), the server computing system, at (218), can update a record based on the response. For example, the server computing system 104 can update the database computing system(s) 108 described above with reference to FIG. 1. The server computing system can transmit data describing the response from the autonomous vehicle computing system in association with the request identifier (e.g., operation ID) to the downstream service. If the transmission of the communication and/or request needs to be retried, at (218), the request can be resent at (212). If the request does not need to be retried, at (218), then the method can end, at (217).

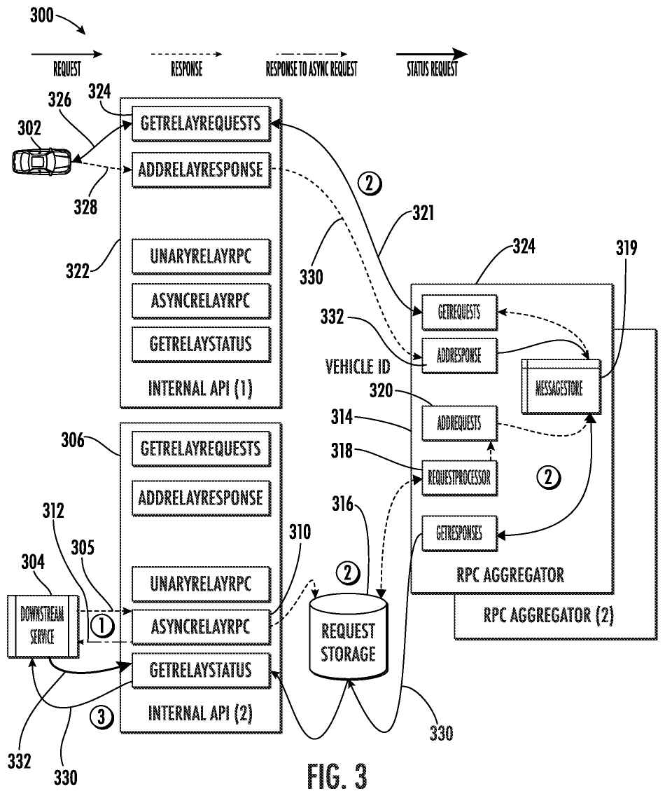

FIG. 3 is a simplified schematic of a system 300 for routing requests to autonomous vehicles 302 from downstream services 304 according to example implementations of the present disclosure. One or more components of the system 300 described below with reference to FIG. 3 can correspond with and/or be included in the server computing system(s) 104 and/or database computing system(s) 108 described above with reference to FIG. 1.

A first internal API instance 306 (e.g., operated by the server computing system) can receive and process a request 305, for example using an Asynchronous Relay Request module 310 of the internal API 306. The asynchronous relay request module 310 of the first internal API instance 306 can assign a request identifier or operation ID to the request 305 and automatically transmit (e.g., return) data 312 describing the operation ID to the downstream service 304.

The internal API 306 can transmit data describing the request to a request aggregator 314. The data describing the request can optionally be stored in a request storage database 316 or the like before or during transmission. A request processor module 318 of the request aggregator 314 can be configured to receive the data describing the request. In some embodiments, the request aggregator 314 can be configured to store data describing the request in a database 319, log, or the like of the request aggregator 314.

Data describing the request 321 can be sent to a second internal API instance 322. For example, the request aggregator 314 can include a get relay request module 324 configured to receive the data 321 describing the request from the request aggregator 314. For example, a Get Request module 324 can be configured to send the data 321 to the second internal API instance 322. The Second Internal API instance 322 can be distinct from the first internal API instance 306. For example, the second internal API instance 322 can operate on a different computing device (e.g., different server device) than the first internal API instance 306. However, in some embodiments, the Second Internal API instance 322 and first internal API instance 306 can correspond with the same entity and/or operate on the same computing device.

The second internal API instance 322 (e.g., the) can be configured to determine when the computing system of the autonomous vehicle 302 is available to receive the data describing request. For example, the second internal API instance 322 can determine that the computing system of the autonomous vehicle 302 is in a powered-on state, has connectivity with respect to the second internal API instance 322 (e.g., operating at the server computing system), and/or is otherwise suitable for receiving the request.

The second internal API instance 322 can transmit the data 326 describing the request to the computing system of the autonomous vehicle 302 when the computing system of the autonomous vehicle 302 is determined to be ready to receive the request.

The system 300 can relay a response to the downstream service 304. For example, the second internal API instance 322 can receive a response 328 from the computing system of the autonomous vehicle 302. The second internal API instance 322 can relay data 330 describing the response 328 to the Request Aggregator 314. The request aggregator 314 can include an add response module 332 configured to receive the data 330. The request aggregator 314 can be configured to store some or all of the data 330 describing the response in the database 319, log, or the like of the request aggregator 314.

The request aggregator 314 can transmit the data 330 describing the response to the first internal API instance 306. In some embodiments, the server computing system can be configured to store the data 330 and/or log information regarding transmission of the data in the request storage database 316 before and/or during transmission of the data 330 to the first internal API instance 306.

The first internal API instance 306 can be configured to relay the data 330 to the downstream service 304. For example, the first internal API instance 306 can receive a query 332 for the response 328 from the autonomous vehicle computing system 302. The query 332 can describe the request identifier associated with the request 305. The first internal API instance 306 can transmit the data 330 describing the response 328 from the autonomous vehicle computing system 302 to the downstream service 304. For example, the first internal API instance 306 can automatically transmit the data 330 describing the response 328 from the autonomous vehicle 302 in response to the receiving the query 332. Thus, the server computing system (e.g., including the first internal API instance 306, request aggregator 324, second internal API instance 322, and/or request storage database 316) can facilitate asynchronous relaying of requests and responses between the autonomous vehicle 302 and the downstream service 304.

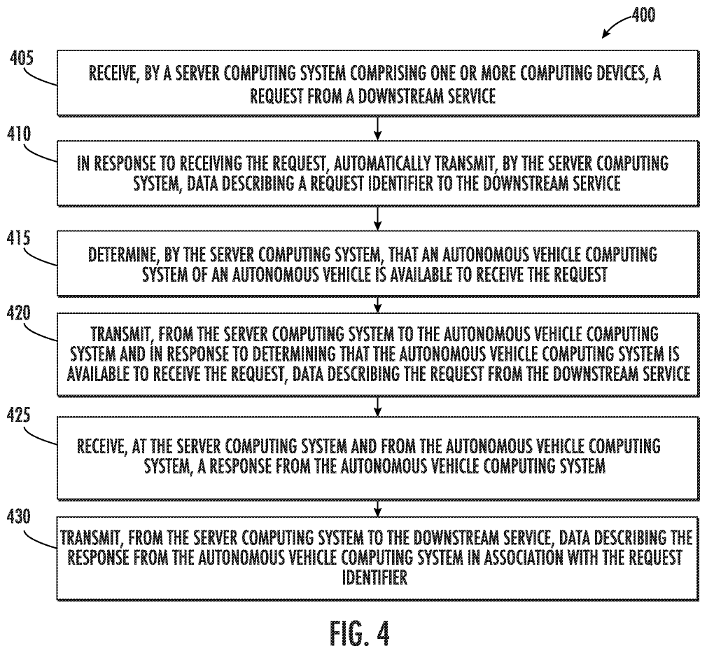

FIG. 4 depicts an example flow diagram of an example method 400 for routing requests to autonomous vehicles. One or more portion(s) of the method 400 can be implemented by a computing system that includes one or more computing devices such as, for example, the computing systems described with reference to the other figures. Each respective portion of the method 400 can be performed by any (or any combination) of one or more computing devices. Moreover, one or more portion(s) of the method 400 can be implemented as an algorithm on the hardware components of the device(s) described herein (e.g., as in FIGS. 1 through 3). FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 4 is described with reference to elements/terms described with respect to other systems and figures for example illustrated purposes and is not meant to be limiting. One or more portions of method 400 can be performed additionally, or alternatively, by other systems.

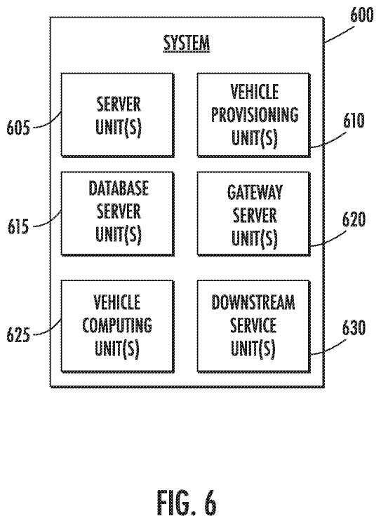

At (405), the method 400 can include receiving, by a server computing system including one or more computing devices, a request from a downstream service. The server computing unit(s) 605 and downstream service unit(s) 630 described below with reference to FIG. 6 are example means for automatically transmitting the data describing a request identifier to the downstream service.

At (410), the method 400 can include, in response to receiving the request, automatically transmitting, by the server computing system, data describing a request identifier to the downstream service. The server computing unit(s) 605 and downstream service unit(s) 630 described below with reference to FIG. 6 are example means for automatically transmitting the data describing a request identifier to the downstream service.

At (415), the method 400 can include determining, by the server computing system, that an autonomous vehicle computing system of an autonomous vehicle is available to receive the request. For example, the server computing system can determine that the autonomous vehicle computing system is online, has the communication bandwidth and/or computational resources to receive the request, and/or meets one or more criteria for determining availability. For instance, the criteria can be defined by the downstream service (e.g., by data associated with the request). The server computing unit(s) 605 described below with reference to FIG. 6 is one example means for determining that an autonomous vehicle computing system of an autonomous vehicle is available to receive the request.

At (420), the method 400 can include transmitting data describing the request from the downstream service from the server computing system to the autonomous vehicle computing system and in response to determining that the autonomous vehicle computing system is available to receive the request. The server computing unit(s) 605 and vehicle computing unit(s) 625 described below with reference to FIG. 6 are example means for transmitting data describing the request from the downstream service from the server computing system to the autonomous vehicle computing system and in response to determining that the autonomous vehicle computing system is available to receive the request.

At (425) the method 400 can include receiving, at the server computing system and from the autonomous vehicle computing system, a response from the autonomous vehicle computing system. The server computing unit(s) 605 described below with reference to FIG. 6 is one example means for receiving a response from the autonomous vehicle computing system from the autonomous vehicle computing system.

At (430), the method 400 can include transmitting, from the server computing system to the downstream service, data describing the response from the autonomous vehicle computing system in association with the request identifier. The server computing unit(s) 605 described below with reference to FIG. 6 is one example means for transmitting data describing the response from the autonomous vehicle computing system in association with the request identifier to the downstream service.

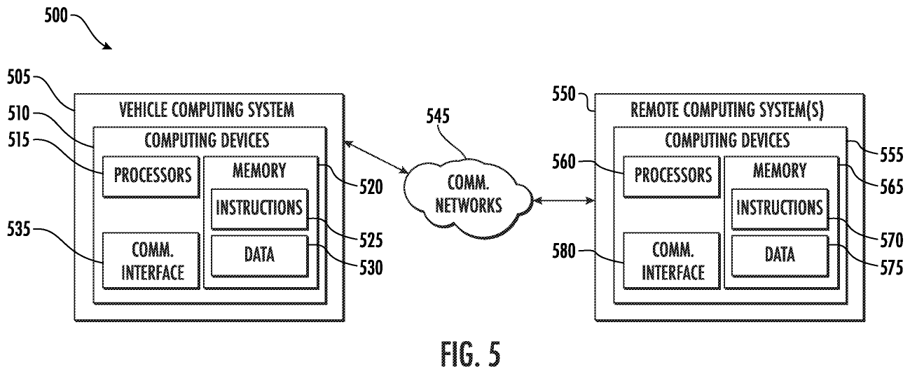

FIG. 5 depicts example system components of an example system 500 according to example implementations of the present disclosure. The example system 500 illustrated in FIG. 5 is provided as an example only. The components, systems, connections, and/or other aspects illustrated in FIG. 5 are optional and are provided as examples of what is possible, but not required, to implement the present disclosure. The example system 500 can include a vehicle computing system 505. The vehicle computing system 505 can include processor(s) 515 and a memory 520. The one or more processor(s) 515 can be any suitable processing device (e.g., a processor core, a microprocessor, an ASIC, a FPGA, a controller, a microcontroller, etc.) and can be one processor or a plurality of processors that are operatively connected. The memory 520 can include one or more non-transitory computer-readable storage media, such as RAM, ROM, EEPROM, EPROM, one or more memory devices, flash memory devices, etc., and/or combinations thereof.

The memory 520 can store information that can be obtained by the one or more processor(s) 515. For instance, the memory 520 (e.g., one or more non-transitory computer-readable storage mediums, memory devices, etc.) can include computer-readable instructions 525 that can be executed by the one or more processors 515. The instructions 525 can be software written in any suitable programming language or can be implemented in hardware. Additionally, or alternatively, the instructions 525 can be executed in logically and/or virtually separate threads on processor(s) 515.

For example, the memory 520 can store instructions 525 that when executed by the one or more processors 515 cause the one or more processors 515 (e.g., of the server computing system 104) to perform operations such as any of the operations and functions described herein. The memory 520 can store data 530 that can be obtained (e.g., received, accessed, written, manipulated, generated, created, stored, etc.). The data 530 can, for instance, describe a status of the vehicle and/or a status of the vehicle computing system at a variety of times and in response to a variety of circumstances and/or events. The data can describe a change in status of an autonomous vehicle and/or reporting of an event with respect to the autonomous vehicle. As examples, the status data can describe events and/or status changes of the autonomous vehicle as part of a service (e.g., rideshare service), such as include picking up user(s), dropping off user(s), picking up item(s), dropping off item(s), and/or other status changes. As additional examples, the status data can indicate or describe the autonomous vehicle having a mechanical issue (e.g., flat tire, air conditioning malfunction, or the like), becoming delayed (e.g., by traffic). Additionally, in some embodiments, the autonomous vehicle can periodically provide status data that describes a location of the autonomous vehicle.

The computing device(s) 510 can also include a communication interface 535 used to communicate with one or more other system(s) (e.g., other systems onboard and/or remote from a vehicle, the other systems of FIG. 1, etc.). The communication interface 535 can include any circuits, components, software, etc. for communicating via one or more networks (e.g., 545). In some implementations, the communication interface 535 can include, for example, one or more of a communications controller, receiver, transceiver, transmitter, port, conductors, software and/or hardware for communicating data/information.

One or more remote computing system(s) 550 can include respective computing devices 555. The remote computing system(s) 550 can correspond with the server computing system 104, third party service(s) 106, and/or operations computing system(s) 109. The processors 555 can be any suitable processing device (e.g., a processor core, a microprocessor, an ASIC, a FPGA, a controller, a microcontroller, etc.) and can be one processor or a plurality of processors that are operatively connected. The memory 565 can include one or more non-transitory computer-readable storage media, such as RAM, ROM, EEPROM, EPROM, one or more memory devices, flash memory devices, etc., and/or combinations thereof.

The memory 565 can store information that can be accessed by the one or more processors 655. For instance, the memory 565 (e.g., one or more non-transitory computer-readable storage mediums, memory devices, etc.) can store data 575 that can be obtained (e.g., generated, retrieved, received, accessed, written, manipulated, created, stored, etc.). The data 575 can include any data described herein as offboard the vehicle. As examples, the data 575 can correspond with data stored by the server computing system(s) 104(e.g., database computing system (s) 108), operating computing system(s) 109, third party service(s) 106.

The memory 565 can also store computer-readable instructions 570 that can be executed by the one or more processors 555. The instructions 570 can be software written in any suitable programming language or can be implemented in hardware. Additionally, or alternatively, the instructions 570 can be executed in logically and/or virtually separate threads on processor(s) 555. The memory 565 can store the instructions 570 that when executed by the one or more processors 555 cause the one or more processors 555 to perform operations such as those of the systems described herein (e.g., offboard the vehicle, etc.). The remote computing system(s) 550 can include a communication interface 660, including devices and/or functions similar to that described with respect to the vehicle computing system 505.

The network(s) 545 can be any type of network or combination of networks that allows for communication between devices. In some embodiments, the network(s) 545 can include one or more of a local area network, wide area network, the Internet, secure network, cellular network, mesh network, peer-to-peer communication link and/or some combination thereof and can include any number of wired or wireless links. Communication over the network(s) 545 can be accomplished, for instance, via a network interface using any type of protocol, protection scheme, encoding, format, packaging, etc.

FIG. 6 depicts system components of an example system 600 according to example implementations of the present disclosure. Various means can be configured to perform the methods and processes described herein. For example, a computing system can include server unit(s) 605, vehicle provisioning unit(s) 610, database server unit(s) 615, gateway server unit(s) 620, vehicle computing unit(s) 625, downstream service unit(s) 630 and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The database server unit(s) 615 can be included in the server computing system or separate and distinct from the server computing system. For example, the database computing system can automatically store the data describing the request in response to the server computing system receiving the request. As another example, the database computing system can automatically store the data describing the request in the database in response to receiving the request. For instance, data describing the request can include the request identifier the response from the autonomous vehicle computing system, and/or metadata associated with the request or one or more components of the system. The database computing system can store metadata describing one or more of the above and/or describing the downstream service, the autonomous vehicle computing system, and/or the autonomous vehicle. The database computing system can maintain a log of data relayed by the server computing system. The log can include information such as an identifier associated with the downstream service, the request identifier, and/or other information describing the downstream service and/or the request. Additional examples of information that can be stored at the database computing system can include a day, time, status, and the like of the request(s). Thus, the database computing system can store information describing relayed requests (e.g., in a database and/or log).

The system can include one or more downstream service unit(s) 630. Alternatively, the downstream service unit(s) 615 can be distinct and separate from the system 600. The downstream service unit(s) 615 can include server computing devices or the like operated by equipment providers, vehicle manufacturers, and the like. The downstream service unit(s) 615 can transmit requests to the server unit(s) 605.

The means can be programmed to receive, at the server computing system, a request from a downstream service. The server computing system unit(s) 605 and the downstream service unit(s) 630 are example means for performing the above steps.

The means can be programmed to automatically transmit data describing a request identifier to the downstream service in response to receiving the request. For instance, the means can generate the request identifier and send the request identifier to the downstream service before further processing or relaying the request. The server computing system unit(s) 605 is one example means for performing the above steps.

The means can be programmed to determine that an autonomous vehicle computing system of an autonomous vehicle is available to receive the request. For example, the means can determine that the autonomous vehicle computing system is online, connected with the server computing system, and/or satisfy one or more other criteria (e.g., with respect to processing capability, memory capability, connectivity bandwidth, and the like). The server computing system unit(s) 605 is one example means for performing the above steps.

The means can be programmed to transmit data describing the request from the downstream service to the autonomous vehicle computing system in response to determining that the vehicle computing system is available to receive the request. The server computing system unit(s) 605 is one example means for performing the above steps.

The means can be programmed to receive from the autonomous vehicle computing system, a response from the autonomous vehicle computing system and transmitting, from the server computing system to the downstream service, data describing the response from the autonomous vehicle computing system in association with the request identifier. The server computing system unit(s) 605 is one example means for performing the above steps.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for routing requests to autonomous vehicles:
a server computing system comprising one or more processors and one or more non-transitory computer-readable media that collectively store instructions that, when executed by the one or more processors, cause the server computing system to perform operations, the operations comprising:
receiving, at the server computing system, a request from a downstream service;
in response to receiving the request, automatically transmitting data describing a request identifier to the downstream service;
determining, by the server computing system, that an autonomous vehicle computing system of an autonomous vehicle is available to receive the request;
transmitting, from the server computing system to the autonomous vehicle computing system and in response to determining that the autonomous vehicle computing system is available to receive the request, data describing the request from the downstream service;
receiving, from the autonomous vehicle computing system, a response from the autonomous vehicle computing system; and
transmitting, from the server computing system to the downstream service, data describing the response from the autonomous vehicle computing system in association with the request identifier.

2. The system of claim 1, wherein the operations further comprise, before determining that the autonomous vehicle computing system of the autonomous vehicle is available to receive the request:
determining, by the server computing system, that the autonomous vehicle computing system of the autonomous vehicle is unavailable to receive the request.

3. The system of claim 2, wherein the operations further comprise, after determining that the autonomous vehicle computing system of the autonomous vehicle is unavailable to receive the request:
monitoring, by the server computing system, an availability status of the autonomous vehicle computing system for receiving the request.

4. The system of claim 1, wherein the operations further comprise, before transmitting, from the server computing system to the downstream service, the data describing the response from the autonomous vehicle computing system in association with the request identifier:
receiving, at the server computing system from the downstream service, a query for the response from the autonomous vehicle computing system, the query describing the request identifier;
wherein transmitting, from the server computing system to the downstream service, the data describing the response from the autonomous vehicle computing system in association with the request identifier comprises automatically transmitting the data describing the response from the autonomous vehicle in response to the receiving the query.

5. The system of claim 1, wherein the operations further comprise, before transmitting, from the server computing system to the autonomous vehicle computing system, the data describing the request from the downstream service:
receiving, at the server computing system from the downstream service, a query for the response from the autonomous vehicle computing system, the query describing the request identifier; and
transmitting, from the server computing system to the downstream service, data describing a status update with respect to the request from the downstream service.

6. The system of claim 1, wherein transmitting, from the server computing system to the downstream service, the data describing the response from the autonomous vehicle computing system in association with the request identifier comprises automatically transmitting the data describing the response in response to receiving the response from the autonomous vehicle computing system.

7. The system claim 1, wherein the operations further comprise automatically storing, in a database associated with the server computing system in response to receiving the request, data describing the request.

8. The system of claim 1, wherein the operations further comprise automatically storing, in a database associated with the server computing system in response to receiving the response from the autonomous vehicle computing system, data that describes the response from the autonomous vehicle computing system.

9. The system of claim 1, wherein determining, by the server computing system, that the autonomous vehicle computing system of the autonomous vehicle is available to receive the request comprises determining that the autonomous vehicle computing system is powered on.

10. The system of claim 1, wherein determining, by the server computing system, that the autonomous vehicle computing system of the autonomous vehicle is available to receive the request comprises determining that autonomous vehicle computing system satisfies one or more criteria in addition to being in a powered-on state.

11. The system of claim 1, wherein the operations further comprise:
before determining, by the server computing system, that the autonomous vehicle computing system of the autonomous vehicle is available to receive the request, receiving, at the server computing system from the downstream service, data that describes one or more criteria for the autonomous vehicle computing system being available to receive the request:
wherein determining, by the server computing system, that the autonomous vehicle computing system of the autonomous vehicle is available to receive the request comprises determining that the autonomous vehicle computing system satisfies the one or more criteria.

12. A method for routing requests to autonomous vehicles:
receiving, by a server computing system comprising one or more computing devices, a request from a downstream service;
in response to receiving the request, automatically transmitting, by the server computing system, data describing a request identifier to the downstream service;
determining, by the server computing system, that an autonomous vehicle computing system of an autonomous vehicle is available to receive the request;
transmitting, from the server computing system to the autonomous vehicle computing system and in response to determining that the autonomous vehicle computing system is available to receive the request, data describing the request from the downstream service;
receiving, at the server computing system and from the autonomous vehicle computing system, a response from the autonomous vehicle computing system; and
transmitting, from the server computing system to the downstream service, data describing the response from the autonomous vehicle computing system in association with the request identifier.

13. The method of claim 12, further comprising, before determining that the autonomous vehicle computing system of the autonomous vehicle is available to receive the request:
determining, by the server computing system, that the autonomous vehicle computing system of the autonomous vehicle is unavailable to receive the request.

14. The method of claim 12, further comprising, after determining that the autonomous vehicle computing system of the autonomous vehicle is unavailable to receive the request:
monitoring, by the server computing system, an availability status of the autonomous vehicle computing system for receiving the request.

15. The method of claim 12, further comprising, before transmitting, from the server computing system to the downstream service, the data describing the response from the autonomous vehicle computing system in association with the request identifier:
receiving, at the server computing system from the downstream service, a query for the response from the autonomous vehicle computing system, the query describing the request identifier;
wherein transmitting, from the server computing system to the downstream service, the data describing the response from the autonomous vehicle computing system in association with the request identifier comprises automatically transmitting the data describing the response from the autonomous vehicle in response to the receiving the query.

16. The method of claim 12, wherein transmitting, from the server computing system to the downstream service, the data describing the response from the autonomous vehicle computing system in association with the request identifier comprises automatically transmitting the data describing the response in response to receiving the response from the autonomous vehicle computing system.

17. The method of claim 12, further comprising automatically storing, by the server computing system and in response to receiving the request, data describing the request in a database at the server computing system.

18. The method of claim 12, wherein determining, by the server computing system, that the autonomous vehicle computing system of the autonomous vehicle is available to receive the request comprises determining that the autonomous vehicle computing system is in a powered-on state.

19. The method of claim 12, wherein determining, by the server computing system, that the autonomous vehicle computing system of the autonomous vehicle is available to receive the request comprises determining that autonomous vehicle computing system satisfies one or more criteria in addition to being in a powered-on state.

20. One or more tangible, non-transitory, computer-readable media that collectively store instructions that, when executed by one or more processors, cause the one or more processors to perform operations, the operations comprising:
receiving, by a server computing system comprising one or more computing devices, a request from a downstream service;
in response to receiving the request, automatically transmitting, by the server computing system, data describing a request identifier to the downstream service;
determining, by the server computing system, that an autonomous vehicle computing system of an autonomous vehicle is available to receive the request;
transmitting, from the server computing system to the autonomous vehicle computing system and in response to determining that the autonomous vehicle computing system is available to receive the request, data describing the request from the downstream service;
receiving, at the server computing system and from the autonomous vehicle computing system, a response from the autonomous vehicle computing system; and
transmitting, from the server computing system to the downstream service, data describing the response from the autonomous vehicle computing system in association with the request identifier.
